(19) United States
(12) Patent Application Publication
(10) Pub. No.: US 2020/0021143 A1
(43) Pub. Date: Jan. 16, 2020

(54) METHOD FOR WIRELESS ENERGY TRANSMISSION FROM AN ENERGY TRANSMISSION DEVICE TO A CONSUMER AND WIRELESS ENERGY TRANSMISSION DEVICE FOR CARRYING OUT THE METHOD

(71) Applicant: Robert Bosch GmbH, Stuttgart (DE)

(72) Inventors: Martin Gonda, Buehl (DE); Dragan Krupezevic, Stuttgart (DE); Juergen Mack, Goeppingen (DE)

(21) Appl. No.: 16/484,006

(22) PCT Filed: Feb. 1, 2018
(86) PCT No.: PCT/EP2018/052504

§ 371 Date: Sep. 5, 2019

(30) Foreign Application Priority Data
Feb. 10, 2017 (DE) 10 2017 202 162.4
Aug. 23, 2017 (DE) 10 2017 214 741.5

(51) Int. Cl. H02J 50/60; H02J 50/10; H02J 7/02; G01V 3/10

(52) U.S. Cl. CPC H02J 50/60; H02J 50/10; B60L 53/124; G01V 3/10; H02J 7/025

(57) ABSTRACT

A method is provided for a wireless, in particular inductive, energy transmission from an energy transmission device to a consumer, and in at least one method task, an interruption of the energy transmission from the energy transmission device to the consumer takes place in conjunction with a foreign object detection. The method provides that a cycle time of the method, and/or a duration and/or frequency of the foreign object detection is/are adapted in at least one method task as a function of a characteristic energy transmission variable of the wireless energy transmission.

### FIELD OF THE INVENTION

The present invention relates to a method for a wireless, in particular inductive, energy transmission from an energy transmission device to a consumer, in which in at least one method step an interruption of the energy transmission from the energy transmission device to the consumer is interrupted in connection with a foreign object detection. In addition, the present invention relates to a wireless energy transmission device, in particular an inductive charging device, for carrying out the method according to the present invention.

### BACKGROUND INFORMATION

It is believed to understood to supply battery-operated handheld devices such as tooth brushes, mobile radio devices or computers as well as electrically operated handheld tools, measuring devices, gardening devices or the like with energy in a wireless manner. In the future, the energy stores of electrically driven vehicles such as e-bikes, e-scooters or passenger cars, buses, trucks etc. will also be wirelessly charged. Other application cases for the wireless energy transmission are devices which are not equipped with an additional energy store or are equipped with only a small energy store, e.g., in the form of capacitors, and which directly consume the wirelessly transmitted energy. Among such devices are kitchen appliances such as mixers, pots, etc. which are operable directly on an induction cooking field, but increasingly also notebooks, lamps, fans and the like. As a rule, the wireless energy transmission takes place with the aid of an electromagnetic field from a primary-side energy supply device to a secondary-side consumer, the primary side and the secondary side each having at least one coil, which are able to be placed at a small distance from each other and which thus essentially form a transformer together.

However, when an electrically conductive foreign object enters the region of the electromagnetic field of the coils, eddy currents may form which heat the foreign object. If the foreign object is magnetizable, then it can also be heated by magnetic reversal losses or hysteresis losses. The heating may be considerable so that an operating safety of the wireless energy transmission system is no longer ensured. In addition, the foreign object may withdraw energy from the electromagnetic field so that the energy transmission to the consumer is disturbed.

From DE 10 2012 205 693 A1, an inductive charging system is discussed which has an inductive charging device for the wireless energy transmission to a battery-powered device, a resonance transformer of the inductive charging device with a charging coil generates an electromagnetic alternating field. A determination device is provided in order to detect an object in the area of the charge coil as a function of an electric parameter at the resonance transformer. In addition, the inductive charging device includes an open-loop and closed-loop control unit for varying a quality factor of the resonance transformer so that an energy transmission at a low quality factor and a detection of the object at a high quality factor are possible.

In addition, a method for a foreign object detection for an inductive charging device is furthermore known from DE 10 2013 212 588, in which a resonant frequency and an associated actual quality of an oscillating switching circuit of the inductive charging device are detected and the actual quality is then compared to a setpoint quality as a function of the resonant frequency. Based on a defined setpoint quality range, a decision is then made regarding the presence of a foreign object.

### SUMMARY OF THE INVENTION

It is an object of the present invention to further improve the methods for foreign object detection known from the related art for a wireless energy transmission device as well as the corresponding wireless energy transmission devices, and to further optimize the energy transmission.

According to the present invention, it is provided that in at least one method step a cycle time of the present method and/or a duration and/or frequency of the foreign object detection is adapted as a function of a characteristic energy transmission variable of the wireless energy transmission. This advantageously makes it possible to minimize interruptions in the wireless energy transmission on account of a required foreign object detection. In addition, long cycles are able to be achieved in a particularly advantageous manner, which results in an overall shortened energy transmission period. A risk of damage to a wireless energy transmitter device, in particular a wireless energy transmission device, is advantageously able to be taken into account when carrying out a foreign object detection.

A “wireless energy transmission device” in particular is meant to describe a primary-side device for the wireless, in particular inductive, transmission of energy to a secondary-side consumer, in particular a rechargeable energy store. One example of a wireless energy transmission is an inductive charging system for a rechargeable battery pack of a handheld machine tool. However, the present invention may also be used for quite different types of wireless energy transmission and also energy transmission and receiving devices in which a foreign object detection is meaningful or necessary. This may also include a wireless energy transmission that is carried out optically, acoustically, capacitively or is based on air flows or the like.

A “frequency” of the foreign object detection in particular describes a frequency of an execution of the foreign object detection during the wireless energy transmission or during a standby operation of the energy transmission device.

The energy transmission device may have at least one open-loop or closed-loop control unit, which is provided at least to control or regulate a wireless energy transmission. A “consumer” is meant to be understood in particular as a device for the temporary storage and/or consumption of electrical energy, such as an accumulator or a device that is directly supplied by the wirelessly transmitted electrical energy, such as a radio, a lamp, a mixer or the like. Different rechargeable energy stores considered useful by one skilled in the art are conceivable, but a lithium-ion accumulator in particular is meant in this context.

In addition, an “open-loop or closed-loop control unit” in particular describes a unit that has at least one control electronics. A “control electronics” particularly is to be understood as a unit having a processing unit and a memory unit as well as an operating program that is stored in the memory unit. The expression that an object is provided for a specific function in particular means that the object satisfies and/or carries out this particular function in at least one application state and/or operating state.

A “foreign object detection” in particular describes a detection of and/or a check for the presence of foreign objects, in particular in an environment of the energy transmission device and/or the consumer. In particular, it may be understood as the detection of and/or the check for the presence of foreign objects that are located in a contact region between the wireless energy transmission device and the consumer and may have an adverse effect on them during a wireless energy transmission. “Foreign objects” in particular should be understood as metallic and/or magnetic components, partial pieces or other objects.

A “characteristic energy transmission variable” in particular describes a characteristic variable which characterizes, which may be in quantitative terms, a flow of energy, in the case of an inductive energy transmission, in particular an electromagnetic flow of energy between the energy transmission device and the consumer during the wireless energy transmission.

It is furthermore provided that in at least one method step, a characteristic precision variable, in particular a number of discrete frequency points and/or a number of frequency sweep cycles of the foreign object detection, is adapted as a function of the characteristic energy transmission variable of the wireless energy transmission. This advantageously makes it possible to achieve a simplified execution of the foreign object detection. In addition, interruptions in the wireless energy transmission caused by an optimized foreign object detection may advantageously be kept to a minimum. A “characteristic precision variable” in particular describes a characteristic variable which at least partially characterizes a precision of the foreign object detection.

A “frequency cycle” in the context of the method according to the present invention is meant to be understood as a process in which a search takes place for a local maximum of an acquired or measured actual quality of the wireless energy transmission within a defined frequency range as a function of the resonant frequency. If such a local maximum is found, then the frequency sweep cycle is usually terminated, thus obviating the need to cycle through all frequency points.

In one advantageous development of the method according to the present invention, it is provided in at least one method step to differentiate between a standard foreign object detection, in particular at a cycle time of 1 to 10 seconds, and a rapid foreign object detection, in particular at a cycle time of less than 10 milliseconds, as a function of the number of discrete frequency points and/or the number of frequency sweep cycles. The standard foreign object detection offers the advantage of a detection of metallic foreign objects the size of a washer, a key, a coin or the like that are located on the energy transmission device or between the energy transmission device and the consumer and that have a longer heating time; in contrast, the rapid foreign object detection is capable of detecting sudden changes, such as the slippage of the consumer relative to the energy transmission device, and of responding faster to, for instance, overvoltages, overtemperatures or the like in the consumer. In comparison with the standard foreign object detection, however, the rapid foreign object detection leads to an overall longer energy transmission because it must be interrupted more frequently by the foreign object detection.

In at least one method task (step), the foreign object detection is able to differentiate between at least a standby mode and an energy transmission mode of the wireless energy transmission, and to carry out a standard foreign object detection when a change takes place from the standby mode to the energy transmission mode or vice versa. This advantageously makes it possible to keep the number of executions of the foreign object detection to a minimum.

In a particularly advantageous manner, a rapid foreign object detection is carried out when the characteristic energy transmission variable has changed only slightly from one cycle to the next of the present method, which may be has changed by less than 10%, and especially particularly, by less than 5%, and most particularly, by less than 1%. In this way the wireless energy transmission as a whole is able to be accelerated without an increased risk with regard to an existing foreign object. In addition, a low risk of damage to the wireless energy transmission device is achievable.

In at least one method step, a subsequent communication between the energy transmission device and the consumer is allocated to the foreign object detection. This advantageously makes it possible to utilize information of the consumer for a subsequent foreign object detection.

It is furthermore provided to suspend the foreign object detection for a defined period of time until a change occurs or until the end of the energy transmission, as a function of an undershooting of an in particular lower limit value by a value of the characteristic energy transmission variable. This makes it possible to realize a rapid wireless energy transmission mode, for example. In essence, a shorter energy transmission period with longer energy transmission cycles is able to be realized in this way.

Alternatively or additionally to the rapid energy transmission mode, it may be provided to continue the energy transmission detection as a function of an exceeding of an in particular upper limit value by a value of the characteristic energy transmission variable, and/or to reduce the cycle time. This ensures that the foreign object detection is able to react as quickly and reliably as possible to sudden changes, errors and/or foreign objects. This basically leads to a longer energy transmission period with shorter energy transmission cycles.

In a particularly advantageous manner, the characteristic energy transmission variable is an electric power transmitted between the energy transmission device and the consumer, or a power gradient; in at least one method step, the cycle time is reduced with a rising amplitude or rising gradient and/or the duration and/or frequency of the object detection is increased with a rising amplitude or a rising gradient. In particular, the frequency during an energy transmission at an average transmission power of between 5 W and 10 W, for instance, may be reduced in comparison with a frequency of an energy transmission at a high transmission power, e.g., of more than 10 W. In a wireless energy transmission at a low transmission power, an execution of the foreign object detection with the previously mentioned advantages may also be completely dispensed with.

Alternatively or additionally, the characteristic energy transmission variable may be a temperature or a temperature gradient measured in the energy transmission device and/or the consumer, and in at least one method step, the cycle time is reduced with a rising amplitude or rising gradient, and/or the duration and/or frequency of the foreign object detection is/are increased with a rising amplitude or a rising gradient.

It is also conceivable that the characteristic energy transmission variable is an energy requirement of the consumer, and in at least one method step, the cycle time is reduced with an increasing energy requirement, and/or the duration and/or the frequency of the foreign object detection is/are increased with an increasing energy requirement.

In the same way, the characteristic energy transmission variable may be a charge state of the consumer developed as a rechargeable energy store, and in at least one method step, the cycle time is increased with a rising charge state and/or the duration and/or the frequency of the foreign object detection is/are reduced with a rising charge state.

In addition, the characteristic energy transmission variable may be a gradient of the acquired actual quality, and in at least one method step, the cycle time is reduced with a rising gradient, and/or the duration and/or frequency of the foreign object detection is/are increased with a rising gradient.

Moreover, a vibration or a vibration gradient measured in the energy transmission device and/or the consumer may be used as the characteristic energy transmission variable, and in at least one method step, the cycle time is reduced with a rising amplitude or a rising gradient, and/or the duration and/or the frequency of the foreign object detection is/are increased with a rising amplitude or rising gradient.

As already mentioned, the differently developed characteristic energy transmission variables allow for a very flexible adaptation of the foreign object detection and the related energy transmission cycles to the individually given transmission situation between the energy transmission device and the consumer.

In one advantageous further development of the method according to the present invention, it is provided that the foreign object detection is carried out at an excitation voltage of the primary-side transmission coil of the energy transmission device of less than 10V, which may be between 2.5V and 5V. In this way, the foreign object detection may be carried out at a negligible transmission power, so that an energy transmission to the consumer is avoided and a resulting faulty measurement of the actual quality is able to be prevented. In this way the consumer also does not supply any “faulty” data values “Rx Data”, e.g., an incorrect charge status of an accumulator to be charged, which could falsify a subsequent foreign object detection. In an advantageous manner, the excitation voltage is selected so that although a wireless energy transmission to the consumer no longer takes place, a communication with the consumer is able to occur. Notable advantages are also the compliance with quiescent current requirements for charging devices in the standby mode as well as also the possibility of secondary-side “open circuit” receiver coils in which the system inductivity is mostly affected only by the shielding.

In addition, the present invention relates to a wireless energy transmission device for carrying out the method according to the present invention for a power range of the wirelessly to be transmitted energy within a lower power limit of 5 W and an upper power limit of 30 W, in particular 15 W. To be mentioned as an example of corresponding energy transmission devices are not only notebooks, tablets, smartphones but also radios, lamps, smaller measuring and handheld machine tools, etc.

In the same way, the present invention may also be developed for wireless energy transmission devices for a power range of the wirelessly to be transmitted energy within a lower power limit of 30 W and an upper power limit of 200 W, in particular 65 W. To be mentioned as representative of this power range are many motor-driven devices such as electric handheld machine tools, e.g., power drills, grinding devices, saws, planes, sanders, etc.; kitchen appliances such as mixers and food processors; as well as electric vehicles, e.g., electric bikes, scooters, etc.

Moreover, the present invention is suitable for wireless energy transmission devices with a power range of the energy to be transmitted in a wireless manner of below a lower power limit of 200 W, in particular 2000 W, such as electrically driven passenger cars, trucks, buses, forklifts or the like, and kitchen appliances such as electric grills, pots or similar devices, as well as stationary electric machine tools and industrial plants.

A handheld machine tool, a kitchen appliance or an electric vehicle for carrying out the method according to the present invention.

Additional advantages of the present invention result from the features set forth in the independent claims and from the drawing as well as the following description.

In the following text, the present invention will be described by way of example with the aid of FIGS. 1 through 4, identical reference numerals in the figures indicating the same components having the same method of functioning.

### BRIEF DESCRIPTION OF THE DRAWINGS

FIG. 1 shows a wireless energy transmission system having a primary energy transmission device and a secondary-side consumer, in a schematic representation.

FIG. 2 shows a schematic diagram of the different working ranges of the wireless energy transmission device.

FIG. 3 shows a program sequence of the method according to the present invention for a wireless energy transmission, in a schematic representation.

FIG. 4 shows a supplementary program sequence of the method according to the present invention for the wireless energy transmission, in a schematic representation.

### DETAILED DESCRIPTION

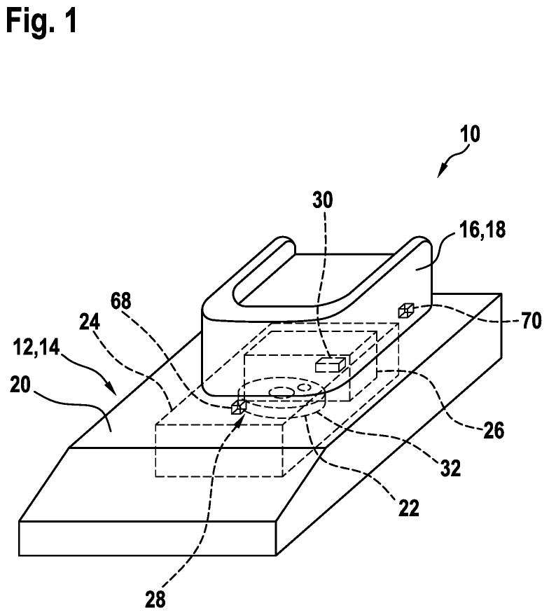

FIG. 1 shows a wireless energy transmission system 10 in the form of an inductive charging system, which includes a primary energy transmission device 14 developed as a charging device 12, and a secondary-side consumer 18, developed as a rechargeable battery pack 16, for a handheld machine tool (not shown).

In the same way, however, consumer 18 may also be a rechargeable battery which is firmly integrated into the handheld machine tool. As mentioned in the introduction, however, the present invention is not restricted to inductive charging systems for handheld machine tools and their rechargeable batteries or battery packs. Instead, it may be used for a wide variety of wireless energy transmission types and for energy transmission and receiving devices for which a foreign object detection is useful or required. This may also include a wireless energy transmission based on an optical, acoustic and capacitive principle or one based on air flows or the like.

FIG. 1 shows rechargeable battery pack 16 placed on a topside of a housing 20 of wireless charging device 12. It is charged via at least one primary-side transmission coil integrated into charging device 12 and a secondary-side receiving coil (not shown) of wireless energy transmission system 10 integrated into rechargeable battery pack 16. Wireless energy transmission system 10 has a primary-side electronics unit 24 in charging device 12 for this purpose, which in turn includes an open-loop and closed-loop control unit 26 as well as an oscillating switching circuit 28 having transmission coil 22.

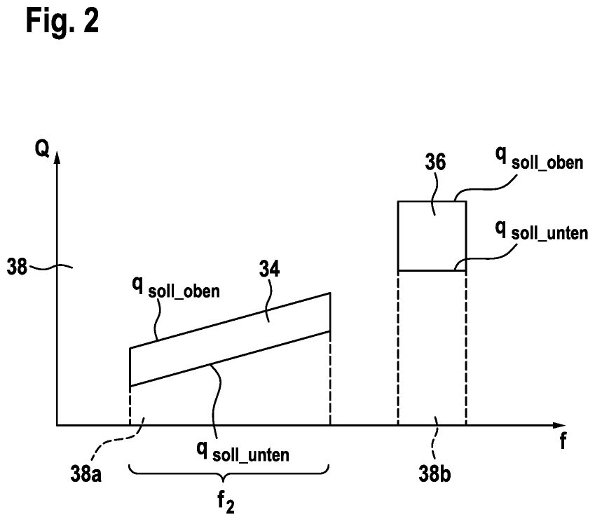

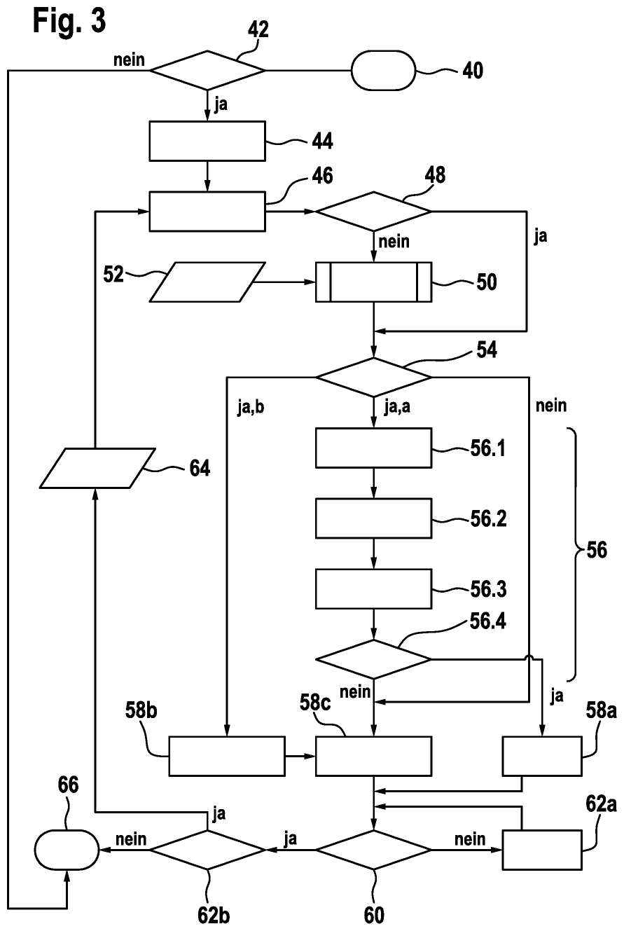

Open-loop and closed-loop control unit 26 of wireless energy transmission system 10 is provided to determine a resonant frequency fᵣₑₛ and an associated actual quality Q_{act}(fᵣₑₛ). In addition, open-loop and closed-loop control unit 26 compares actual quality Q_{act} to a setpoint quality Qₜₐᵣ(fᵣₑₛ) as a function of the resonant frequency fᵣₑₛ. Toward this end, open-loop and closed-loop control unit 26 includes a memory 30, which stores a setpoint quality range qₜₐᵣ having a plurality of setpoint qualities Qₜₐᵣ(fᵣₑₛ) for ascertained resonant frequency fᵣₑₛ (see also the following statements in connection with FIGS. 2 and 3).

During the wireless energy transmission, a foreign object detection is carried out at defined time intervals T_{cycle}, such as every second, in which it is checked whether one or a plurality of foreign object(s) 32 that may have an adverse effect on the energy transmission and/or that could pose a safety risk is/are situated between energy transmission device 14 and consumer 18 or simply only on energy transmission device 14. The foreign object detection operates essentially in such a way that resonant frequency fᵣₑₛ and associated actual quality Q_{act}fᵣₑₛ are determined to begin with, and actual quality Q_{act} (fᵣₑₛ ) is subsequently compared to setpoint quality Qₜₐᵣ (fᵣₑₛ) as a function of resonant frequency fᵣₑₛ. Finally, based on defined setpoint quality range qₜₐᵣ, a decision is made about the operating state of wireless energy transmission system 10 or energy transmission device 14.

The foreign object detection is carried out using an excitation voltage of primary-side transmission coil 22 of energy transmission device 14 of less than 10V, which may be between 2.5V and 5V. This allows the foreign object detection to be carried out at a negligible transmission power so that an energy transmission to the consumer is able to be avoided and a resulting faulty measurement of actual quality Q_{act} (fᵣₑₛ) may be prevented. In this way, consumer 18 also does not send any “faulty” data values to energy transmission device 14, e.g., an incorrect charge status of an accumulator to be charged, which could falsify a subsequent foreign object detection.

FIG. 2 shows setpoint quality ranges qₜₐᵣ stored in memory 30 of open-loop and closed-loop control unit 26 in the form of a schematic diagram in which resonant frequency fᵣₑₛ is plotted on the abscissa and quality Q is plotted on the ordinate. The diagram is subdivided into three ranges 34, 36, 38 (38a, 38b). A first range 34 defines a setpoint quality range qₜₐᵣ for an operation using consumer 18. If actual quality Q_{act} (fᵣₑₛ) lies between an upper limit q_{tar_up} and a lower limit q_{tar_lo} of first range 34, then it is assumed that no foreign object 32 that has an effect on the energy transmission is situated on wireless energy transmission device 14. Moreover, a wireless energy transmission from energy transmission device 14 to consumer 18 is assumed in this range. A second range 36 defines a setpoint quality range qₜₐᵣ for a standby operation without an applied consumer 18. If actual quantity Q_{act} (fᵣₑₛ) lies between upper limit q_{tar_up} and lower limit q_{tar_lo} of second range 36, then it is assumed that neither a foreign object 32 nor a consumer 18 is situated on wireless energy transmission device 14.

A third range, which has two second subranges 38a, 38b, is formed by an error range. As a matter of principle, an error may lie in the wireless energy transmission system 10, in energy transmission device 14, in consumer 18 and also in an environment of energy transmission system 10. A first subrange 38a lies below lower limit q_{tar_lo} of first range 34 in relation to quality Q, and a second subrange 38b lies below lower limit q_{tar_lo} of second range 36. If actual quality Q_{act} (fᵣₑₛ) lies within first subrange 38a, it is assumed that at least one foreign object 32 is located on energy transmission device 14 or between energy transmission device 14 and consumer 18 in a region that has an effect on it during the energy transmission. Here, too, it may be assumed that a random fault has occurred, or that consumer 18 is positioned on wireless energy transmission device 14 in such an unfavorable position that an energy transmission is impossible or possible only with considerable restrictions. If actual quality Q_{act} (fᵣₑₛ) lies within second subrange 38b, then it is assumed that at least one foreign object 32 is situated on wireless energy transmission device 14 during the standby operation.

The following non-linear relationship, which may be gathered from FIG. 2, applies to the characteristic of actual quality Q_{act}. If the distance between consumer 18 and energy transmission device 14 enlarges, then both resonant frequency fᵣₑₛ and actual quality Q_{act} (fᵣₑₛ) increase. The same may be noticed when consumer 18 is shifted or positioned outside its optimal position—the center of the at least one primary-side transmission coil 22 on the surface of energy transmission device 14—regardless of the direction. These two cases describe quite frequently occurring scenarios. For example, a lateral offset of consumer 18 with respect to energy transmission device 14 has to be permitted because a user will normally not always be able to place the secondary-side receiving coil of consumer 18 in an exactly centered manner over the at least one transmission coil 22 of energy transmission device 14. This is particularly the case when energy transmission device 14 has a planar surface without mechanical guide aids for consumer 18 or if—as in the case of a vehicle to be charged—the positions of the at least one primary-side transmission coil 22 and/or the at least one secondary-side receiving coil are not precisely known or able to be seen. In addition, in particular when consumer 18 is set down directly on energy transmission device 14, vertical tilting is conceivable as a result of foreign objects 32 between consumer 18 and energy transmission device 14.

FIG. 3 shows a program sequence of the method for a wireless energy transmission according to the present invention. After start 40, what is known as a power-on self-test (POST) of energy transmission device 14 is carried out in first step 42. Start 40 may take place automatically when consumer 18 is placed on energy transmission device 14, or when a button (not shown) on energy transmission device 14 and/or consumer 18 is operated. If the POST in step 42 was run through successfully, open-loop and closed-loop control unit 26 of energy transmission device 14 automatically initializes resonant frequency f res actual quality Q_{act} (fᵣₑₛ) and cycle period T_{cycle} of the following method steps in a second step 44, with fᵣₑₛ=f_{stdby}, Q_{act,n} (fᵣₑₛ)=O and T_{cycle}=Tₘᵢₙ, where f_{stdby} describes a permissible resonant frequency in the standby operation (see FIG. 2), and Tᵣₐᵢₙ describes a minimum cycle period (e.g., 10 ms). Alternatively, it is also possible to initially set T_{cycle} to Tₘᵢₙ=O.

In next step 46, an actual quality Q_{act,n+1} (fᵣₑₛ) is initially measured for the initialized resonant frequency and then compared in fourth step 48 to initialized actual quality Q_{act,n} (fᵣₑₛ). Since there is no agreement between the initialized and the measured actual quantity immediately following the start of the method for the wireless energy transmission, this is followed in a fifth method step by a partial process, carried out by open-loop and closed-loop control unit 26 in the form of a frequency sweep, such that open-loop and closed-loop control unit 26 actuates a frequency unit (not shown) of primary-side electronics unit 24, the frequency unit being connected upstream from oscillating switching circuit 28. One skilled in the art is essentially familiar with the actuation of such an oscillating switching circuit for carrying out a frequency sweep. For this reason, no further details will be provided in this context.

To determine resonant frequency f res a resonance magnification at primary transmission coil 22 is detected in fifth step 50 during the frequency sweep. Using the amplitude ascertained at the location of the resonance magnification, actual quality Q_{act,n+1} (fᵣₑₛ) is then able to be calculated in the known manner; the location of the resonance magnification corresponds to the ascertained frequency fᵣₑₛ. In a seventh step 54, these two values are then compared to setpoint quality range qₜₐᵣ, which is stored in memory 30 of open-loop and closed-loop control unit 26 (step 52, see also FIG. 2).

If actual quality Q_{act,n+1} (fᵣₑₛ) lies between the upper and the lower limit q_{tar_up}, q_{tar_lo} of first range 34 according to FIG. 2, then it may be assumed that no foreign object 32 that could affect the upcoming wireless energy transmission is located on wireless energy transmission device 14, so that the method for the wireless energy transmission runs through the following partial process 56, which is made up of four partial steps 56.1, 56.2, 56.3, 56.4, in which a communication between energy transmission device 14 and consumer 18 is established and checked. In first partial step 56.1, open-loop and closed-loop control unit 26 of energy transmission device 14 generates a synchronization pulse and transmits it to consumer 18, which may be via primary-side transmission coil 22 and the secondary-side receiving coil. Alternatively, some other wireless data transmission, e.g., via Bluetooth, optically, acoustically or the like, would also be conceivable for the communication between energy transmission device 14 and consumer 18. When the required received data “Rx Data” of consumer 18 are received in second partial step 56.2 by primary-side electronics unit 24 of energy transmission device 14 following the synchronization pulse, then the coupling between energy transmission device 14 and consumer 18 is able to be checked in third partial step 56.3. If the check of the coupling and the received data is successful, a decision is made in fourth partial step 56.4 to start the wireless energy transmission to consumer 18 according to an eighth step 58a. However, if the check is not successful, an error and/or a foreign object 32 is/are assumed in an alternative, eighth step 58c.

If actual quality Q_{act,n+1} (fᵣₑₛ) lies between the upper and lower limit q_{tar_up}, q_{tar_lo} of second range 36 according to FIG. 2, then it is assumed that wireless energy transmission system 10 is in a standby operation and no foreign object 32 is present on wireless energy transmission device 14. The method for the wireless energy transmission thus jumps from sixth step 52 directly to a further, alternative eighth step 58b.

If the result between actual quality Q_{act,n+1} (fᵣₑₛ) and setpoint quality Q_{act} (fᵣₑₛ) in sixth step 52 reveals that actual quality Q_{act,n+1} (fᵣₑₛ) lies outside setpoint quality range qₜₐᵣ, then an error and/or an existing foreign object 32 is/are assumed in step 58c according to the above statements in connection with FIG. 2.

Starting from the three possible eighth steps 58a (operation for a wireless energy transmission, 58b (standby operation), 58c (error or foreign object is detected), a decision is made in a ninth method step 60 as to whether the adjusted cycle time T_{cycle} has exceeded a maximum cycle time Tₘₐₓ of one second, for example. T_{cycle} defines a length of time between two consecutive passes through the method for the wireless energy transmission according to the present invention. On the other hand, steps 46 through 58 of the method for wireless energy transmission according to the present invention normally last only a few milliseconds and depend considerably on the processing power of primary-side open-loop and closed-loop control unit 26. As long as cycle time T_{cycle} has not yet exceeded maximum cycle time Tₘₐₓ in ninth step 60, it is increased to a specified value, successively or a single time, in a tenth step 62a. While cycling through steps 60 and 62a, the actual method for detecting the operating types and/or errors or foreign objects according to steps 46 through 58 has already been concluded so that the wireless energy transmission according to step 58a, the standby operation according to step 58b, or an interruption of the energy transmission or the standby operation according to step 58c is carried out as a function of the decision made in sixth step 54 until T_{cycle} has exceeded maximum cycle time Tₘₐₓ. A decision is then made in step 62b as to whether the method is to be repeated or terminated. In the case of a repeat, the currently stored actual quality Q_{act},ₙ(fᵣₑₛ) is set to the value of current actual quality Q_{act,n+1} (fᵣₑₛ) of the past cycle in an eleventh step 64, and cycle time T_{cycle} is set to minimum value Tₘᵢₙ. The method then begins anew with third step 46 and the measurement of a new actual quality Q_{act,n+1} (fᵣₑₛ), in which the subsequent frequency sweep according to step 50 is omitted if the currently stored and new actual quality do not differ due to Q_{act,n+1} (fᵣₑₛ)=Q Q_{act,n} (fᵣₑₛ).

If an error was determined in first step 42 during the POST or if a decision was made in eleventh step 64 not to repeat the cycle, then the method according to the present invention for the wireless energy transmission is stopped by final step 66.

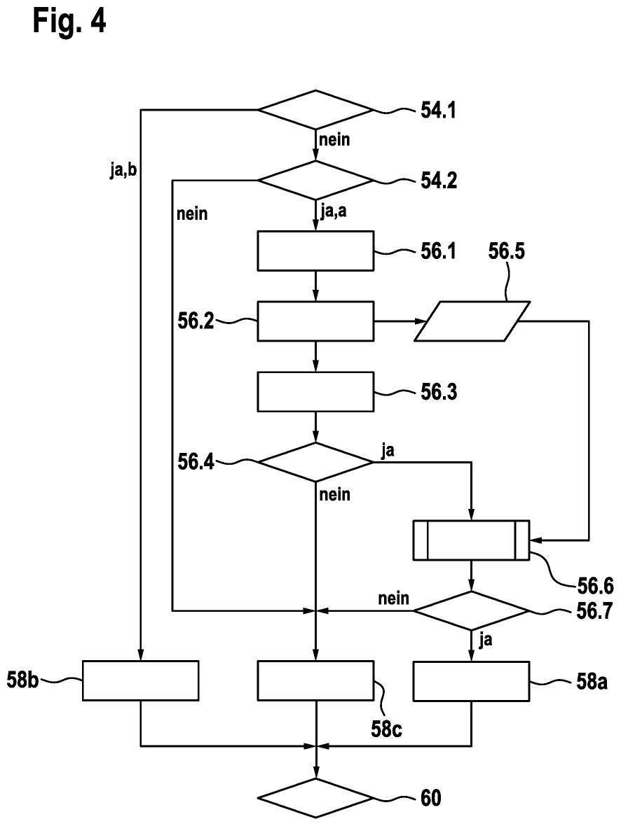

Of particular importance for the method for the wireless energy transmission according to the present invention are the data “Rx Data” received in second partial step 56.2 of partial process 56 according to FIG. 4. In this context, the flow diagram illustrated in FIG. 4 shows only a section of the program sequence shown in FIG. 3, in which identical method steps have been provided with the same reference numerals in each case and seventh method step 54 was split up into two partial steps 54.1 and 54.2.

If actual quality Q_{act,n+1} (fᵣₑₛ) lies between the upper and lower limit q_{tar_up}, q_{tar_lo} of second range 36 according to FIG. 2 in partial step 54.1, then it is assumed according to FIG. 3 that wireless energy transmission system 10 is in a standby operation and no foreign object 32 is situated on wireless energy transmission device 14. The method for the wireless energy transmission thus jumps directly to eighth step 58b from sixth step 52. However, if actual quality Q_{act,n+1} (fᵣₑₛ) lies outside second range 36 in partial step 54.1, then it is checked in a following partial step 54.2 whether it lies between the upper and the lower limit q_{tar_up}, q_{tar_lo} of first range 34 according to FIG. 2. If this is not the case, then an error and/or a foreign object 32 is/are assumed in step 58c. In contrast, if actual quality Q_{act,n+1} (fᵣₑₛ) corresponds to a setpoint quality Qₜₐᵣ (fᵣₑₛ) of first range 34, then a communication to consumer 18 is built up in following partial process 56.

According to the present invention, in partial steps 56.5 and 56.6 as additional steps in comparison with FIG. 3, it is now provided to take a characteristic energy transmission variable into account for the following foreign object detection, the variable being derivable from the received data of consumer 18 “Rx Data” and/or data sensed in energy transmission device 14. The characteristic energy transmission variable in particular is a characteristic variable that characterizes, which may be in quantitative terms, an energy flow during the wireless energy transmission, in the case of an inductive energy transmission, in particular an electromagnetic energy flow, between energy transmission device 14 and consumer 18. For example, the characteristic energy transmission variable may be an electric power transmitted between energy transmission device 14 and consumer 18 or a power gradient; a temperature or a temperature gradient; a required energy requirement of consumer 18; a charge state of consumer 18, developed as a rechargeable energy store;

a gradient of acquired actual quality Q_{act,n+1} (fᵣₑₛ); a vibration or a vibration gradient measured in the consumer; and/or an item of authenticating information regarding the right of consumer 18 to the wireless energy transmission.

Alternatively or additionally, however, electronics unit 24 of energy transmission device 14 may also include a sensor unit 68 which is connected to open-loop and closed-loop control unit 26 and provided for the continuous or quasi-continuous acquisition of the characteristic energy transmission variable. In this way, the acquisition may be undertaken both during the foreign object detection and during the wireless energy transmission, during the standby operation, or also during an interruption of the energy transmission as a result of a detected error and/or foreign object. A corresponding sensor unit 70 may additionally or alternatively also be required in consumer 18 for generating the above received data “Rx Data” (see FIG. 1). The sensor device may be made up of a wide variety of sensors such as a shunt resistance, a temperature probe, an acceleration sensor, a yaw rate sensor, and also an air pressure sensor, a moisture sensor or the like. Since one skilled in the art is quite familiar with corresponding sensors, no further description will be given here. The sensed characteristic energy transmission variable may thus involve an electric current or current gradient in transmission coil 22; an electric voltage or a voltage gradient applied at transmission coil 22; a temperature or a temperature gradient of transmission coil 22; an accepted power or a power gradient of a power supply unit of energy transmission device 14; a supply voltage or a supply voltage gradient of the power supply unit of energy transmission device 14, or the like. Also conceivable as a characteristic energy transmission variable is a measured vibration or a vibration gradient of energy transmission device 14.

In the same way, it would be conceivable to develop the characteristic energy transmission variable as a function of an installation location of energy transmission device 14, e.g., in a stationary form in a workshop or in mobile form in a vehicle.

For instance, the installation location is able to be determined based on the measured vibration or the measured vibration gradient of energy transmission device 14. It is also possible, however, to utilize existing speed and/or GPS data of a vehicle or the like toward this end.

To optimize the foreign object detection, different parameters for controlling the foreign object detection are able to be determined from the characteristic energy transmission variable with the aid of open-loop and/or closed-loop control unit 26. In at least one partial step 56.6, at least one characteristic precision variable, e.g. a number of discrete frequency points and/or a number of frequency sweep cycles (see step 50 in FIG. 3) of the foreign object detection is determined as a function of the at least one characteristic energy transmission variable. In addition, a duration and/or frequency, in particular a frequency of an execution of the foreign object detection during the wireless energy transmission, is able to be determined as a function of the at least one characteristic energy transmission variable. For example, the frequency during the wireless energy transmission at a medium transmission power, e.g., a transmission power of between 5 W and 10 W, may be reduced in comparison with a frequency during a wireless energy transmission at a high transmission power, e.g., a transmission power of more than 10 W. During a wireless energy transmission at a low transmission power, an execution of a foreign object detection may be dispensed with completely. In addition, in partial step 56.6, maximum cycle time Tₘₐₓ and/or a length of time of the frequency sweep to be carried out in step 50 is/are able to be determined as a function of the at least one characteristic energy transmission variable.

Based on the measures specified in partial step 56.6, a decision is made in final partial step 56.7 whether the foreign object detection is able to be deactivated for a defined period of time or for the remaining energy transmission, and/or whether the limit values specified in step 56.6 of resonant frequency fᵣₑₛ and actual quality Q_{act,n+1} (fᵣₑₛ) inventive for the energy transmission process were complied with. If this is the case and if the foreign object detection was cycled through without an error, then the energy is able to be transmitted in step 58a in a wireless manner from energy transmission device 14 to consumer 18. However, if it was decided in partial step 56.7 that the limit values were exceeded or that the foreign object detection may not be suspended, then an error or an existing foreign object 32 is inferred according to step 58c, so that no further energy transmission takes place until the decision about the repeat of the cycle in step 62b.

Open-loop and/or closed-loop control unit 26 of energy transmission device 14 continuously monitors the energy transmission for irregularities as a function of cycle time T_{cycle}. If open-loop and/or closed-loop control unit 26 detects a change in time, in particular an amplitude fluctuation and/or a gradient, of the characteristic energy transmission variable, then the energy transmission is interrupted and a renewed foreign object detection is initiated according to steps 60 through 64 illustrated in FIG. 3.

In partial step 56.7, the foreign object detection in partial step 56.7 is suspended for a defined period of time or until the end of the energy transmission as a function of an undershooting of an in particular lower limit value by a value of the characteristic energy transmission variable, this being done by increasing maximum cycle time Tₘₐₓ correspondingly in partial step 56.6. In partial step 56.7 a decision is made as a function of an exceeding of an in particular upper limit value by a value of the characteristic energy transmission variable as to whether to carry on with the execution of the foreign object detection and/or to reduce maximum cycle time Tₘₐₓ in partial step 56.6. In particular, the execution of the foreign object detection is suspended when a lower limit value of a transmission power is not attained, such as in a drop of the transmission power to a value of below 5 W. The foreign object detection resumes again when a specified limit value of the transmission power is exceeded.

It should finally also be pointed out that the illustrated exemplary embodiment is neither restricted to the FIGS. 1 through 4 nor to the mentioned power and voltage values. In particular, the present invention may also be used in wireless energy transmissions at transmission powers of considerably more than 10 W, e.g. for applications in kitchens or electric vehicles.

1-20. (canceled)

21. A method for a wireless energy transmission from an energy transmission device to a consumer, the method comprising:
performing an interruption of the energy transmission from the energy transmission device to the consumer in conjunction with a foreign object detection; and
adapting a cycle time of the method, and/or a duration and/or frequency of the foreign object detection as a function of a characteristic energy transmission variable of the wireless energy transmission.

22. The method of claim 21, wherein in the adapting, a characteristic precision variable, in particular a number of discrete frequency points and/or a number of frequency sweep cycles of the foreign object detection, is adapted as a function of the characteristic energy transmission variable of the wireless energy transmission.

23. The method of claim 22, wherein it is differentiated between a standard foreign object detection, in particular at a cycle time of 1 to 10 seconds, and a rapid foreign object detection, in particular at a cycle time of less than 10 milliseconds, as a function of the number of discrete frequency points and/or the number of frequency sweep cycles.

24. The method of claim 23, wherein the foreign object detection is able to differentiate between at least a standby mode and an energy transmission mode of the wireless energy transmission, and a standard object detection is carried out in a change from the standby mode to the energy transmission mode, or the reverse.

25. The method of claim 23, wherein a rapid foreign object detection is carried out when the characteristic energy transmission variable has changed only slightly from one cycle to the next of the method, preferably by less than 10%.

26. The method of claim 21, wherein a subsequent communication between the energy transmission device and the consumer is allocated to the foreign object detection.

27. The method of claim 21, wherein the foreign object detection is suspended for a defined period of time as a function of an undershooting of an in particular lower limit value by the value of the characteristic energy transmission variable, until a change occurs or until the end of the energy transmission.

28. The method of claim 21, wherein the foreign object detection continues to be carried out and/or the cycle time is reduced as a function of an exceeding of an in particular upper limit value by a value of the characteristic energy transmission variable.

29. The method of claim 21, wherein the characteristic energy transmission variable is an electric power or a power gradient transmitted between the energy transmission device and the consumer, and the cycle time is reduced with a rising amplitude or rising gradient, and/or the duration and/or frequency of the foreign object detection is/are increased with a rising amplitude or rising gradient.

30. The method of claim 21, wherein the characteristic energy transmission variable is a temperature or a temperature gradient measured in the energy transmission device and/or the consumer, and the cycle time is reduced with a rising amplitude or rising gradient, and/or the duration and/or frequency of the foreign object detection is/are increased with a rising amplitude or a rising gradient.

31. The method of claim 21, wherein the characteristic energy transmission variable is an energy requirement of the consumer, and the cycle time is reduced with a rising energy requirement, and/or the duration and/or frequency of the foreign object detection is/are increased with an increased energy requirement.

32. The method of claim 21, wherein the characteristic energy transmission variable is a charge state of the consumer configured as a rechargeable energy store, and the cycle time is increased with a rising charge state, and/or the duration and/or the frequency of the foreign object detection is/are reduced with a rising charge state.

33. The method of claim 21, wherein the characteristic energy transmission variable is a gradient of an acquired actual quality, and the cycle time is reduced with a rising gradient, and/or the duration and/or the frequency of the foreign object detection is/are increased with a rising gradient.

34. The method of claim 21, wherein the characteristic energy transmission variable is a vibration or a vibration gradient measured in the energy transmission device and/or the consumer, and the cycle time is reduced with a rising amplitude or a rising gradient, and/or the duration and/or the frequency of the foreign object detection is/are increased with a rising amplitude or a rising gradient.

35. The method of claim 21, wherein the characteristic energy transmission variable is an electric current or a current gradient in the transmission coil of the energy transmission device, an electric voltage or a voltage gradient applied at the transmission coil and/or a temperature or a temperature gradient of the transmission coil, and the cycle time is reduced with a rising amplitude or a rising gradient, and/or the duration and/or frequency of the foreign object detection is/are increased with a rising amplitude or a rising gradient.

36. The method of claim 21, wherein the characteristic energy transmission variable is an accepted power or a power gradient of a power supply unit of the energy transmission device, and/or a supply voltage or a supply voltage gradient of the power supply unit of the energy transmission device, and the cycle time is reduced with a rising amplitude or a rising gradient, and/or the duration and/or frequency of the foreign object detection is/are increased with a rising amplitude or a rising gradient.

37. The method of claim 21, wherein the foreign object detection is carried out at an excitation voltage of a primary-side transmission coil of the energy transmission device of less than 10V, or between 2.5V and 5V.

38. A wireless energy transmission apparatus for providing a wireless energy transmission from the transmission apparatus to a consumer, comprising:
a wireless energy transmission device configured to perform the following:
performing an interruption of the energy transmission from the wireless energy transmission device to the consumer in conjunction with a foreign object detection; and
adapting a cycle time of the method, and/or a duration and/or frequency of the foreign object detection as a function of a characteristic energy transmission variable of the wireless energy transmission;
wherein the wireless energy transmission device is configured for a power range of the wirelessly to be transmitted energy within a lower power limit of 5 W and an upper power limit of 30 W or 15 W.

39. The wireless energy transmission device of claim 38, wherein the wireless energy transmission device is configured for a power range of the wirelessly to be transmitted energy within a lower power limit of 30 W and an upper power limit of 200 W or 65 W.

40. The wireless energy transmission device of claim 38, wherein the wireless energy transmission device is configured for a power range of the wirelessly to be transmitted energy above a lower power limit of 200 W or 2000 W.

41. The wireless energy transmission device of claim 38, wherein the wireless energy transmission device is inductive.

42. The method of claim 23, wherein a rapid foreign object detection is carried out when the characteristic energy transmission variable has changed only slightly from one cycle to the next of the method, by less than 5%.

43. The method of claim 23, wherein a rapid foreign object detection is carried out when the characteristic energy transmission variable has changed only slightly from one cycle to the next of the method, by less than 1%.

44. The method of claim 23, wherein the wireless energy transmission device is inductive.
